(19) United States
(12) Patent Application Publication
(10) Pub. No.: US 2024/0341235 A1
(43) Pub. Date: Oct. 17, 2024

(54) SYSTEM AND METHOD FOR APPLYING FLUID TO A CUTTING BLADE

(71) Applicant: CNH Industrial America LLC, New Holland, PA (US)

(72) Inventors: Christopher Schoeny, Minooka, IL (US); Michael Gregory Adams, Lancaster, WI (US); Alison Marie Bryan, Mahomet, IL (US); Darian E. Landolt, Evanston, IL (US)

(21) Appl. No.: 18/133,742

(22) Filed: Apr. 12, 2023

(51) Int. Cl. A01D 45/02; A01B 35/32

(52) U.S. Cl. CPC A01D 45/021; A01B 35/32

(57) ABSTRACT

An agricultural system includes a harvester that may include a chopper configured to cut crop residue from the crop. The harvester may also include a fluid applicator configured to apply harvest-aid fluid to the chopper. The agricultural system may also include an application control system that may include a memory and a processor. The application control system may be configured to receive crop harvest data indicative of a density or an expected density of crops within a field. The application control system may also determine a harvest-aid fluid application rate based on the crop harvest data. Further, the application control system may control the fluid applicator to apply the harvest-aid fluid to the chopper based on the harvest-aid fluid application rate.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plant crops. The harvester may include or be coupled to a header, which may be designed to efficiently harvest certain types of crops. For example, a corn header may be designed to efficiently harvest corn. The corn header may include row units that each include components that operate to separate the ear of corn from the remainder of the corn plant as the harvester travels through a field. The remaining corn plant material is often left in the field to decompose and enhance the soil quality for future crop development.

A tillage system may be used to cultivate the soil through tilling operation. Common tilling operations include plowing, harrowing, sub-soiling, and vertical tillage. The tillage system may include disc blades that are positioned vertically on a tillage implement to cut into the soil and crop residue from previous agricultural operations. These disc blades chop up the crop residue and help incorporate it within the soil to aid in decomposition to add nutrients for future crop growth. Farmers perform these tilling operations by pulling a tilling implement behind a motorized tractor. Depending on the crop selection and the soil conditions, a farmer may perform several tilling operations at different times over a crop cycle to properly cultivate the land to suit the crop choice.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some embodiments, an agricultural system may include a harvester that may include a chopper configured to cut crop residue from the crop. The harvester may also include a fluid applicator configured to apply harvest-aid fluid to the chopper. The agricultural system may also include an application control system that may include a memory and a processor. The application control system may be configured to receive crop harvest data indicative of a density or an expected density of crops within a field. The application control system may also determine a harvest-aid fluid application rate based on the crop harvest data. Further, the application control system may control the fluid applicator to apply the harvest-aid fluid to the chopper based on the harvest-aid fluid application rate.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an agricultural system, in accordance with an embodiment of the present disclosure;

FIG. 2 is a perspective view of a header that may be employed within a harvester of the agricultural system of FIG. 1, in accordance with an embodiment of the present disclosure;

FIG. 3 is a perspective front view of a portion of the header of FIG. 2, in accordance with an embodiment of the present disclosure;

FIG. 4 is a perspective bottom view of a portion of the header of FIGS. 2 and 3, in accordance with an embodiment of the present disclosure;

FIG. 5 is a front view of a chopper system that may be employed within the header of FIGS. 2 and 3, in accordance with an embodiment of the present disclosure;

FIG. 6 is a side view and a front view of a row of disc blades that may be employed within a tillage implement of the agricultural system of FIG. 1, in accordance with an embodiment of the present disclosure;

FIG. 7 is a flowchart of a method for operating the agricultural system of FIG. 1 based on seed planting data, in accordance with an embodiment of the present disclosure; and

FIG. 8 is a flowchart of a method for operating the agricultural system of FIG. 1 based on crop residue data, in accordance with an embodiment of the present disclosure;

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure relates generally to an agricultural system and, more specifically, to introducing a decomposition-aid to crop residue by applying the decomposition-aid to a blade making contact with crop residue.

The process of farming typically begins with planting seeds within a field. Over time, the seeds grow and eventually become harvestable crops. Typically, only a portion of each crop is commercially valuable, so each crop is harvested to separate the usable material from the remainder of the crop. For example, a harvester may include or be coupled to a header to harvest crops within the field. The header may be a corn header that is configured to efficiently harvest corn within the field. The corn header may include multiple row units arranged across a width of the corn header, and each row unit may include deck plates, stalk rollers, other component(s), or a combination thereof, that operate to separate ears of corn from stalks and materials other than grain (e.g., crop residue) as the harvester travels through the field. For example, corn headers are capable of chopping the stalks of corn quickly and collecting the corn ears while leaving behind the stalks, leaves, and any other unwanted and biodegradable byproduct. Conveyors (e.g., augers) carry the ears of corn into the harvester (e.g., a chassis of the harvester), such as toward processing machinery of the harvester, for further processing.

The crop residue left behind from the header is often intentionally left in the field following the harvest. As the crop residue decomposes, nutrients from the rotting crop residue are incorporated into the soil. As more crop residue decomposes, more nutrients are incorporated into the soil. Crops grown in fields with higher nutrient content and soil quality often grow larger, faster, and with a lower risk of crop failure. As such, it is common in traditional agriculture systems to perform tillage operations following harvest operations. Tillage systems are used to further aid in the decomposition process for the remaining crop residue. Tillage implements are often pulled behind work vehicles to cut up remaining crop residue and incorporate the crop residue into the soil. For example, the disc blades of a tillage implement facilitate soil movement and ensure a homogenous mixture while facilitating the break down of degradable plant matter.

However, decomposition can be a slow process relative to the schedule for planting, watering, harvesting, and tilling. If the soil does not contain the proper nutrients by the time that the next group of seeds is planted, the crop growth may be stunted. For these reasons, it is desirable that the decomposition of crop residue occurs at a reasonable speed and that the soil is ready for planting by the predefined deadline. Some current agricultural systems incorporate a decomposition-aid to the crop residue and the soil to speed up the natural decomposition process. The decomposition-aid may be a fluid that is applied to the crop residue that contains microbes and/or materials that promote microbe development. In many cases, the decomposition-aid is sprayed onto the crop residue following harvesting operations to evenly coat an entire field. Unfortunately, traditional methods for applying decomposition-aid may not be efficient. For example, crop residue may be unevenly distributed throughout the field. Accordingly, when evenly spraying an entire field with decomposition-aid, a first section of the field with a higher crop residue concentration may receive proportionally less decomposition-aid than a second section of the field with a lower crop residue concentration. A portion of the decomposition-aid used in the second section may go to waste while the crop residue in the first section may not decompose at a desired rate due to an insufficient amount of decomposition-aid. Current systems may be both inefficient with the use of decomposition aid fluid and insufficient in providing the necessary nutrients to all of the soil in a field.

Thus, it is presently recognized that a system to distribute a target amount of decomposition-aid to the crop residue during harvest and tillage operations may improve the health of the soil and enhance future crop yields. Accordingly, the present embodiments relate to systems and methods for applying a decomposition-aid fluid to the cutting blades of a harvester and/or a tillage implement to incorporate the decomposition-aid into the soil to facilitate decomposition of crop residue with a reduction in wasted decomposition-aid. The harvester/tillage implement may include or be communicatively coupled to an application control system configured to determine a target fluid application rate to the cutting blades based on tillage and/or harvest data received by the application control system. As an example, based on the amount of crop residue detected in the path of the tillage implement, the application control system may adjust the amount of decomposition-aid being applied to the cutting blades as the tillage implement cuts the crop residue, thereby effectively supporting decomposition while reducing decomposition-aid waste.

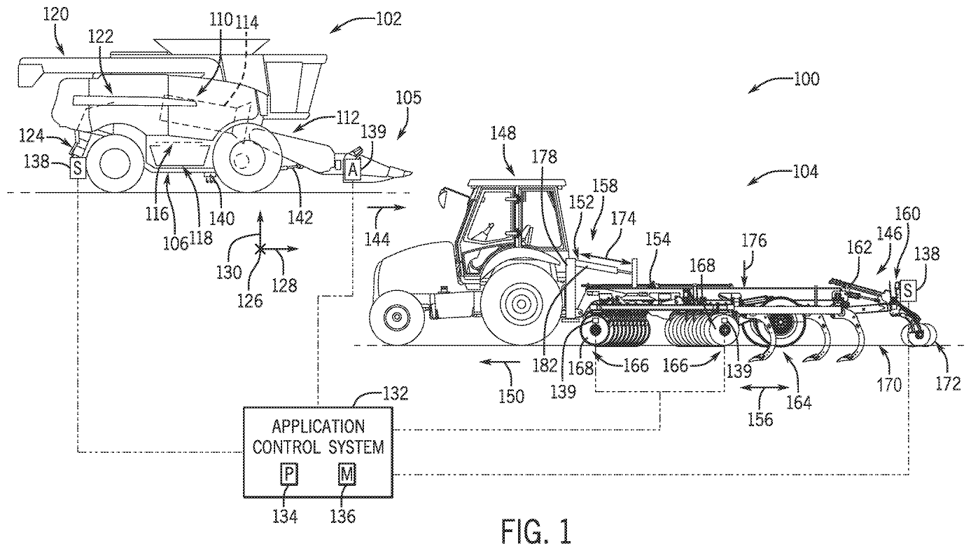

With the foregoing in mind, FIG. 1 is a side view of an embodiment of an agricultural system 100, which may include a harvester 102, a tillage system 104, or both. The harvester 102 includes a chassis 106 configured to support a header 108 (e.g., a corn header, a wheat header) and an agricultural crop processing system 110. The header 108 is configured to receive crops (e.g., corn, wheat) from a field and to transport the crops toward an inlet 112 of the agricultural crop processing system 110 for further processing of the crops. The header 108 may also separate desirable crop material from crop residue (e.g., stems, leaves, stalks). The agricultural crop processing system 110 receives the crops from the header 108 for further processing. For example, the agricultural crop processing system 110 may include a thresher 114 having a cylindrical threshing rotor that transports the crops in a helical flow path through the harvester 102. In addition to transporting the crops, the thresher 114 may further separate certain desirable crop material (e.g., corn) from crop residue (e.g., husks, cobs) and may enable the desirable crop material to flow into a cleaning system 116 (e.g., including sieves) located beneath the thresher 114. The cleaning system 116 may remove debris from the desirable crop material and transport the desirable crop material to a storage tank 118 within the harvester 102. A tractor with a trailer may be positioned alongside the harvester 102. The desirable crop material collected in the storage tank 118 may be transported by an elevator to an unloader 120 and delivered from the unloader 120 into the trailer.

The header 108 may directly distribute/discharge certain crop residue (e.g., stalks, leaves, etc.) to the field to avoid entry of the crop residue into certain parts of the chassis 106, such as the agricultural crop processing system 110. In some embodiments, the harvester 102 includes a crop residue handling system 122 that receives crop residue from the crop processing system 110, which is not directly discharged from the header 108, and the crop residue handling system 122 transports the crop residue to a crop residue spreading system 124 positioned at an aft end of the harvester 102. The crop residue spreading system 124 distributes the crop residue onto the field to facilitate performance of other operations. Distribution of the crop residue onto the field may facilitate a subsequent operation that removes, chops, buries, or otherwise processes the crop residue for subsequent preparation of the field. To facilitate discussion herein, the header 108 may be described with reference to a lateral axis or direction 126, a longitudinal axis or direction 128, and a vertical axis or direction

The agricultural system 100 also includes an application control system 132 (e.g., an automation controller, an electronic controller, a programmable controller, a cloud computing system, control circuitry) with a processor 134 (e.g., processing circuitry) and memory 136. The processor 134 may be used to execute software code or instructions stored on the memory 136, such as to process signals, control operations of the harvester 102, the tillage system 104, or both. The term “code” or “software code” used herein refers to any instructions or set of instructions that control the operation of the application control system 132. The code or software code may exist in a computer-executable form, such as machine code, which is the set of instructions and data directly executed by the processor 134 of the application control system 132, human-understandable form, such as source code, which may be compiled in order to be executed by the processor 134 of the application control system 132, or an intermediate form, such as object code, which is produced by a compiler. In some embodiments, the application control system 132 may include a plurality of controllers.

As an example, the memory 136 may store processor-executable software code or instructions (e.g., firmware or software), which are tangibly stored on a non-transitory computer readable medium. Additionally or alternatively, the memory may store data. As an example, the memory 136 may include a volatile memory, such as random access memory (RAM), and/or a nonvolatile memory, such as read-only memory (ROM), flash memory, a hard drive, or any other suitable optical, magnetic, or solid-state storage medium, or a combination thereof. Furthermore, the processor 134 may include multiple microprocessors, one or more “general-purpose” microprocessors, one or more special-purpose microprocessors, and/or one or more application specific integrated circuits (ASICS), or some combination thereof. For example, the processor 134 may include one or more reduced instruction set (RISC) or complex instruction set (CISC) processors. The processor 134 may include multiple processors, and/or the memory 136 may include multiple memory devices. The processor 134 and/or the memory 136 may be located in any suitable portion of the harvester 102, the tillage system 104, or both (e.g., a cab of the harvester 102, a cab of the tillage system 104, on the header 108, on the tillage implement frame, or some combination thereof). Further, the application control system 132 may be a distributed controller with the multiple processors 134 and/or the multiple memories 136 in separate housings or locations (e.g., in the agricultural system 100, in the header 108, in a remote location, in the cloud).

The application control system 132 may be communicatively coupled to the harvester 102 and the tillage system 104. In some embodiments, the harvester 102 and the tillage system 104 may both be coupled to the same application control system 132. In some embodiments, the agricultural system may include multiple application control systems 132, in which each application control system 132 is communicatively coupled to each of the harvester 102, the tillage system 104, and other agricultural implement(s) of the agricultural system. In this way, the memory 136 and the processor 134 of the application control system 132 that is coupled to the harvester may be distinct from the memory 136 and the processor 134 of the application control system 132 that is coupled to the tillage system 104. In some embodiments, the software code or instructions executed by the processor 134 associated with the harvester 102 may be independent of the software code or instructions executed by the processor associated with the tillage system 104. The application control system 132 may deliver first instructions to the harvester 102 and second instructions to the tillage system 104.

In the illustrated embodiment, the application control system 132 is communicatively coupled to one or more sensors 138 and to a fluid applicator 139 located within the header 108 of the harvester 102. Thus, the application control system 132 may be in communication with the one or more sensors 138 and the fluid applicator 139 to control the application of a harvest-aid fluid by the fluid applicator 139. The harvest-aid fluid may be any suitable fluid or substance found within a fluid that aids in the crop development process, such as herbicide, fertilizer, decomposition-aid fluid (e.g., including microbes, materials that promote microbe development), and the like. For example, the sensor 138 may be used to detect plant matter and crop residue left behind from the harvesting operations of the harvester 102. The application control system 132 may output instructions to the fluid applicator 139 that includes starting application, stopping application, an amount of harvest-aid fluid to be applied, a type of harvest-aid fluid to apply, a frequency rate of applying the harvest-aid fluid, where to apply the harvest-aid fluid (e.g., decomposition-aid fluid), and the like. As another example, the application control system 132 may output a control signal to adjust operation of the header 108 to adjust how the harvest-aid fluid is being applied to the crop residue (e.g., corn stalks). For instance, as discussed herein, the header 108 may include blades that chop the crop residue into finer particles, and the application control system 132 may output the control signal to adjust operation of the blades to adjust the amount of fluid applied to the crop residue (e.g., to compensate for a smaller or larger particle size).

In some embodiments, the application control system 132 may output the control signal to adjust the operation of the fluid applicator 139 of the header 108 automatically. To this end, the application control system 132 is communicatively coupled to the one or more sensors 138 configured to monitor one or more characteristic(s) of the crop residue. By way of example, the sensor(s) 138 may detect a size of the crop residue (e.g., crop residue processed by the header 108), a distribution of the crop residue on the field, other suitable characteristic(s), or any combination thereof. For example, the sensor 138 may include an optical sensor (e.g., a camera) and/or a radar sensor positioned underneath the chassis 106, behind the chassis 106 (e.g., adjacent to the crop residue spreading system 124), or otherwise oriented to face the field to facilitate determination of characteristic(s) of the crop residue. The sensor 138 may output sensor data indicative of the monitored characteristic(s) to the application control system 132, and the application control system 132 may operate based on the received sensor data. For example, the application control system 132 may output a control signal to adjust operation of the fluid applicator 139 of the header 108 based on at least one characteristic of the crop residue (e.g., in response to determining the at least one characteristic is outside of a range of values). In some embodiments, the one or more sensors 138 may be positioned in front of the crop residue spreading system 124. In this way, the one or more sensors 138 may monitor residue from the header 108 so that control of fluid at the header 108 is based on crop residue located near the header 108.

In additional or alternative embodiments, the application control system 132 may output the control signal in response to receipt of a user input. For example, the agricultural system 100 may include a user interface (e.g., disposed in a cab), which may include a touchscreen, a dial, a lever, a switch, a button, a trackpad, a mouse, and the like, and the application control system 132 may receive the user input based on an interaction between a user (e.g., an operator) and the user interface. The user input may, for instance, include a request for directly adjusting operation of the fluid applicator 139 (e.g., regardless of the characteristic(s) of the crop residue monitored by the sensor). The application control system 132 may also be configured to output a control signal to adjust operation of another element of the agricultural system 100. For example, the control signal may be indicative of instructions to provide a notification (e.g., a visual output, an audio output, a communication transmitted to a mobile device) that may prompt a user to manually adjust and/or inspect operation of the agricultural system 100.

In certain embodiments, the sensor may monitor characteristic(s) of upcoming crops to be harvested by the harvester 102. Thus, the application control system 132 may receive information regarding the crop residue that is still intact and attached to the field (e.g., the soil), such as of crops that are upstream of the harvester 102 relative to a direction of travel of the harvester 102. As such, the application control system 132 may adjust operation in anticipation of processing the upcoming crop residue to improve size reduction and/or application of harvest-aid fluid to the crop residue. That is, the application control system 132 may dynamically adjust operations to process the crop residue in a more suitable manner based on the detected characteristic(s) of the upcoming crop residue.

In certain embodiments, the sensor 138 may monitor positioning of the crop residue with respect to the harvester 102 to identify uneven distribution of the crop residue, such as the crop residue being processed or already processed by the header 108. Such uneven distribution may indicate undesirable operation of the harvester 102. For example, uneven distribution at the header 108 may indicate an insufficient speed of operation of rollers of one or more row unit(s) of the header 108. An uneven distribution at the crop residue spreading system 124 may indicate an insufficient speed of operation of a spreader of the crop residue spreading system 124, an insufficient speed of operation of the row unit rollers of the header 108, ineffective operation of another component configured to deliver the crop residue to the crop residue spreading system 124, or a combination thereof. The one or more sensors 138 may output sensor data indicative of a detected uneven distribution, including a location of the uneven distribution congestion, to the application control system 132, and the application control system 132 may output the control signal based on the detected congestion. For instance, the control signal may adjust operation of the fluid applicator 139 to reduce congestion and improve crop residue processing operations.

Additionally or alternatively, the control signal may adjust operation of another component of the agricultural system 100 to reduce the uneven distribution. By way of example, discharged crop residue that is inadequately distributed on the field may be lodged between the field and the agricultural system 100 (e.g., an underside of the chassis) to affect (e.g., obstruct) navigation by the agricultural system 100. The sensor 138 may detect such a congestion, and the application control system 132 may output the control signal to adjust operation of an air mover 140 (e.g., a fan, a blower) to output air that causes movement of the crop residue about the field (e.g., underneath the chassis) and reduce the congestion.

The operation of the agricultural system 100 effectuated by the application control system 132 may enable the harvester 102 to process the crop residue in a desirable manner without causing excessive resource consumption (e.g., of fuel, of electricity) by the agricultural system 100. By way of example, increasing an operating speed of a spreader may process the crop residue more desirably, such as by improving decomposition of crop residue after harvesting and/or reducing a size of the crop residue, but may also increase resource consumption by the harvester 102. For this reason, the application control system 132 may output the control signal to achieve desirable characteristic(s) of the crop residue without causing substantial resource consumption by the harvester. For example, in response to determining that a characteristic (e.g., size, distribution, congestion) of detected crop residue is undesirable (e.g., outside of a desirable range), the application control system 132 may output the control signal to incrementally or gradually increase operation of the fluid applicator 139 until the characteristic is desirable (e.g., within the desirable range) and no additional resources beyond the resources consumed to achieve the desirable characteristic (e.g., harvest-aid fluid) are consumed.

The application control system 132 may also operate other components of the agricultural system 100. For example, the application control system 132 may determine an amount of crop material (e.g., based on sensor data received from the sensor 138 and/or from an additional sensor, such as an optic sensor, a flow sensor, a force sensor, a weight sensor, or a contact sensor) being transported to the inlet 112 for processing by the thresher 114, and the application control system 132 may operate the thresher 114 based on the amount of crop material. In some embodiments, the application control system 132 may output a control signal to increase a processing speed of the thresher 114 in response to determining the amount of harvest-aid fluid is above a threshold value, thereby increasing operation of the thresher 114 to process the crop material and apply harvest-aid fluid to the crop residue during a shorter period of time. In this way, the thresher 114 may operate more suitably to process the increased amount of harvest-aid fluid. The application control system 132 may also output a control signal to reduce the processing speed of the thresher 114 in response to determining the amount of harvest-aid fluid being applied is below a threshold value, thereby reducing resource consumption associated with the operation of the thresher 114. As such, the thresher 114 may operate without expending additional resources than that used to sufficiently process the reduced amount of crop material.

As mentioned above, the agricultural system 100 includes the tillage system 104, which includes a tillage implement 146 coupled to a work vehicle 148, such as a tractor or other agricultural work vehicle. In general, the implement 146 may be configured to be towed along a forward direction of travel 150 by the work vehicle 148. For example, the work vehicle 148 may be coupled to the implement 146 via a hitch system or hitch assembly 152 or using any other suitable attachment. As shown, the hitch system 152 is coupled to a frame 154 (e.g., main frame) of the implement 146 to facilitate towing the implement 146 in the direction of travel 150.

As shown, the frame 154 extends in the longitudinal direction 128 (e.g., as indicated by arrow 156 in FIG. 1) between a forward end 158 and an aft or rear end 160. The frame 154 may also extend in the lateral direction 126 between a first side 162 and a second side. In addition, the frame 154 may generally include multiple structural frame members, such as beams, bars, and/or the like, configured to support and/or couple to multiple components.

The implement 146 further includes wheel assemblies 164 coupled to the frame 154 to support the frame 154 relative to the ground and to facilitate towing the implement 146 in the direction of travel 150. For example, in certain embodiments, the implement 146 may include multiple center support wheel assemblies 164 (e.g., transport wheels) located centrally on the frame 154 between the forward and aft ends 158, 160, with the wheel assemblies 164 being spaced apart from one another in the lateral direction 126 of the implement 146 between the first side 162 and the second side. In certain embodiments, the implement 146 may also include multiple forward support wheel assemblies 164 coupled to the frame 154 adjacent to the forward end 158 of the frame 154, with the wheel assemblies 164 being spaced apart from one another in the lateral direction 126 of the implement 146 between the first side 162 and the second side. The implement 146 may include any suitable number and/or type of wheel assemblies 164 in alternate embodiments.

Referring still to FIG. 1, the implement 146 may also include multiple ground-engaging tools supported by the frame 154. For example, in certain embodiments, the frame 154 may be configured to support one or more gangs or sets 166 of disc blades 168 adjacent the forward end or portion 158 and adjacent the aft end or portion 160, in which the disc blades 168 are configured to till the soil 170. In such embodiments, each disc blade 168 may, for example, include both a concave side and a convex side. Furthermore, the gangs 166 of disc blades 168 may be oriented at an angle relative to the travel direction 150 to promote effective tilling of the soil 170. Additionally, in certain embodiments, the implement 146 may also include one or more finishing assemblies 172, and the frame 154 may be configured to support the finishing assemblies 172 adjacent to the aft end 158. The finishing assembly/assemblies are configured to reduce the number of clods in the soil 170 and/or firm the soil 170 over which the implement 146 travels.

In addition to the gangs 166 of disc blades 168 and the finishing assemblies 172 shown in FIG. 1, the implement 146 may include any other/additional suitable ground-engaging tools. For instance, if the implement 146 is configured as a cultivator or ripper, the implement 146 may include multiple shanks, harrow tines, leveling blades, and/or the like.

In certain embodiments, the hitch system 152 is a weight transferring hitch system. The hitch system 152 is configured to be coupled to the frame 154 of the agricultural implement 146 and to transfer weight (as indicated by arrow 174) between the work vehicle 148 (e.g., tractor) and the agricultural implement 146 to adjust a downward force 176 applied by each disc blade 168 (e.g., of one or more disc gangs 166 coupled to the main frame 154 of the tillage system 104) to the soil 170. In certain embodiments, weight is transferred from the work vehicle 148 to the main frame 154 of the implement 146 and the disc blades 168 to increase the force applied by the disc blades 168 to the soil 170. In certain embodiments, static weight (e.g., a percentage of static weight) is transferred from the agricultural implement 146 to the work vehicle 148 to decrease the force applied by the disc blades 168 to the soil (e.g., as well as the weight on the transport wheels 164 of the agricultural implement) during a tillage operation.

The weight transferring hitch system 152 includes an interface portion 178 (e.g., rigid structure such as a bar or a post) on the frame 154 that is configured to rigidly mount or attach the agricultural implement 146 to the work vehicle 148 (e.g., to a hitch (e.g., three-point hitch) or hitch replacement of the work vehicle 148). As depicted, the interface portion 178 extends in a vertical direction 130.

The weight transferring hitch system 152 also includes a hydraulic cylinder 182 coupled to the interface portion 178 and the main frame 154 of the tillage implement 146. The hydraulic cylinder 182 is configured to apply pressure to the interface portion 178 to adjust the downward force 176 applied to the main frame 154 and the disc blades 168. The hydraulic cylinder 182 is coupled (e.g., fluidly coupled) to a hydraulic system located on the tillage system 104 (e.g., on the work vehicle 148). The weight transferring hitch system 152 may be controlled in a variety of different ways. In certain embodiments, the hydraulic system includes a mechanical valve disposed upstream of the weight transferring hitch system 152 that regulates the hitch system 152. For example, the mechanical valve is set to a specific pressure and when actuated causes the hitch system 152 to transfer weight between the work vehicle 148 and the agricultural implement 146 to cause a specific downward force to be applied by the disc blades 168.

In the illustrated embodiment, the tillage system 104 includes one or more sensors 138 and a fluid applicator 139, and the sensor(s) 138 and the fluid applicator 139 are communicatively coupled to the application control system 132. The fluid applicator 139 of the tillage system 104 may be located within the tillage implement 146. In some embodiments, the fluid applicator 139 may be disposed alongside the gangs 166 of disc blades 168. The tillage implement 146 may include multiple fluid applicators 139 disposed alongside the separate gangs 166 of disc blades 168. The one or more fluid applicators 139 may each be in communication with the application control system 132. Each of the fluid applicators 139 may receive similar or individual instructions from the application control system 132. A first fluid applicator of the fluid applicators 139 may be disposed alongside a first gang of disc blades and a second fluid applicator may be disposed alongside a second gang of disc blades. In some embodiments, the application control system 132 may output instructions to the first fluid applicator that are independent from instructions sent to the second fluid applicator. For example, the application control system 132 may output a first instruction to the first fluid applicator to apply a larger amount of fluid to the disc blades 168 of the first gang, and the application control system 132 may output a second instruction to the second fluid applicator to apply a smaller amount of fluid to the disc blades 168 of the second gang. The first gang of disc blades may contact a larger amount of crop residue and, therefore, utilize a larger amount of tillage-aid fluid (e.g., decomposition-aid fluid), as compared to the second gang of disc blades.

The tillage system 104 may include one or more sensors 138 disposed along the tillage implement 146 and/or the work vehicle 148. For example, the application control system 132 may output a control signal to adjust operation of the fluid applicator(s) 139 of the gang(s) 166 of disc blades 168 based on at least one characteristic of the residue (e.g., in response to determining the at least one characteristic is outside of a range of values). In additional or alternative embodiments, the application control system 132 may output the control signal in response to receipt of a user input. For example, the agricultural system 100 may include a user interface (e.g., disposed in the work vehicle 148), which may include a touchscreen, a dial, a lever, a switch, a button, a trackpad, a mouse, and the like, and the control system may receive the user input based on an interaction between a user (e.g., an operator) and the user interface. The user input may, for instance, include a request for directly adjusting operation of the fluid applicator(s) 139 (e.g., regardless of the characteristic(s) of the crop residue monitored by the sensor(s) 138).

The configuration of the implement 146 described above and shown in FIG. 1 is provided only to place the present subject matter in an exemplary field of use. Thus, the present subject matter may be readily adaptable to any manner of implement configuration.

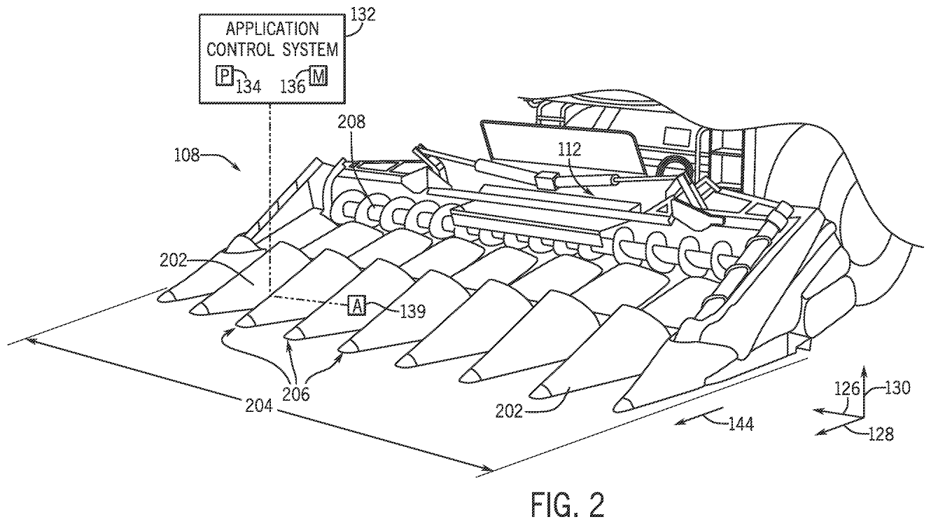

FIG. 2 is a perspective view of an embodiment of the header 108 that may be employed within the harvester 102 of the agricultural system of FIG. 1. In the illustrated embodiment, the header 108 is a corn header and includes multiple dividers 202 configured to separate rows of a crop (e.g., corn). The dividers 202 may be distributed across a width 204 of the header 108 (e.g., along the lateral axis 126). As the header 108 moves along a path, the dividers 202 may direct the crops from each row to row units 206. The row units 206 are configured to receive each crop (e.g., a stalk). A portion of the crops are directed to one of a pair of conveyors 208 (e.g., augers) configured to convey the portion of crops laterally inward to a center crop conveyor at a center of the header 108, and the center crop conveyor directs the portion of crops toward the inlet 112 of the agricultural crop processing system. As illustrated, the conveyors 208 extend along a substantial portion of the width 204 of the header 108 (e.g., along the lateral axis 126). The conveyors 208 may be driven by a drive mechanism (e.g., electric motor, hydraulic motor).

The header 108 may separate the desirable crop material and crop residue from one another to facilitate directing the desirable crop material into the agricultural crop processing system via the inlet 112 and to block entry of the crop residue into the agricultural crop processing system via the inlet 112. For example, operation of the row units 206 may direct the desirable crop material to the conveyors 208 and discharge the crop residue away from the conveyors 208, such as discharging the crop residue directly onto the field. The application control system 132 may operate the fluid applicator 139 as the harvester 102 cuts the crops, separates the crop residue from the desirable crop material, and discharges the crop residue (e.g., onto the field). For example, as discussed herein, the application control system 132 may output a control signal to the one or more fluid applicators 139 to apply a harvest-aid fluid to the stalks of corn as the header 108 operates.

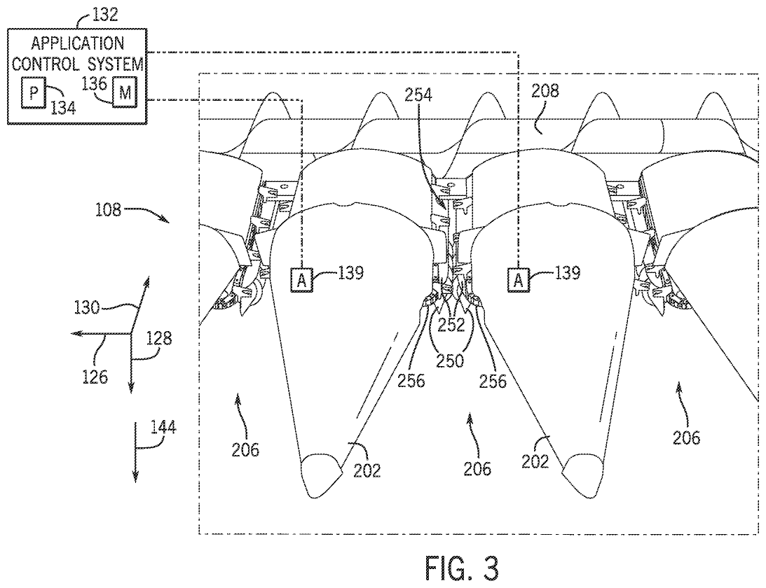

FIG. 3 is a perspective front view of a portion of the header 108 of FIG. 2. As shown, the portion of the header 108 includes the dividers 202 that direct the crops to the row units 206. Each row unit 206 includes various components that operate to separate the corn from the crop residue, carry the corn toward the conveyors 208, and return the crop residue to the field. For example, each row unit 206 may include a pair of feed rollers 250 (e.g., snap rollers, stalk rollers, pick rollers) that are configured to grip the crop (e.g., stalk) and rotate in opposite rotational directions to drive the crop residue of the crop toward the field (e.g., vertically downward along the vertical axis 130; below the header 108) for discharge from the header 108. Each row unit 206 also includes a pair of deck plates 252 that are positioned over the pair of feed rollers 250. Each deck plate 252 extends from a first end to a second end along the longitudinal axis 128, and the pair of deck plates 252 are separated from one another along the lateral axis 126 to define a gap 254. The pair of deck plates 252 are spaced apart so that the gap 254 is sized to enable the crop residue to move through the gap 254, but to block the desirable crop material (e.g., cars of corn) from moving through the gap 254. Accordingly, the deck plates 252 may receive the desirable crop material and block entry of the desirable crop material through the gap 254. Further, each row unit 206 may include a pair of chains 256 (e.g., with lugs) that are configured to drive or push the desirable crop material along the pair of deck plates 252 toward the conveyors 208. In some embodiments, the pair of deck plates 252 are adjustable and may be driven (e.g., via an actuator) toward and away from one another along the lateral axis 126 to change a size of the gap 254 (e.g., a width along the lateral axis 126).

Additionally, the application control system 132 may operate the fluid applicators 139 based on a detected rate of crop movement into the row units 206. For example, during operation, the harvester 102 may move in the direction of travel 146 to gather multiple rows of crops. The travel speed of the harvester 102 in the direction of travel 146 may affect intake of the crop residue by the row units 206. For example, increased travel speed may cause more crops to enter each row unit 206, thereby generating more residue. In addition, a higher crop density within the field may cause more crops to enter each row unit 206, thereby generating more residue. Accordingly, the application control system 132 may control the amount of harvester aid fluid that is applied to choppers disposed below the row units 206 based on the detected rate of crop movement into each row unit. As a result, the choppers disposed below the row units 206 that process more residue may receive a larger amount of fluid to compensate for the larger amount of crop residue. Conversely, the choppers disposed below the row units 206 that process less residue may receive a smaller amount of fluid. In this way, the harvest-aid fluid is used efficiently, and less harvest-aid fluid is wasted during operation.

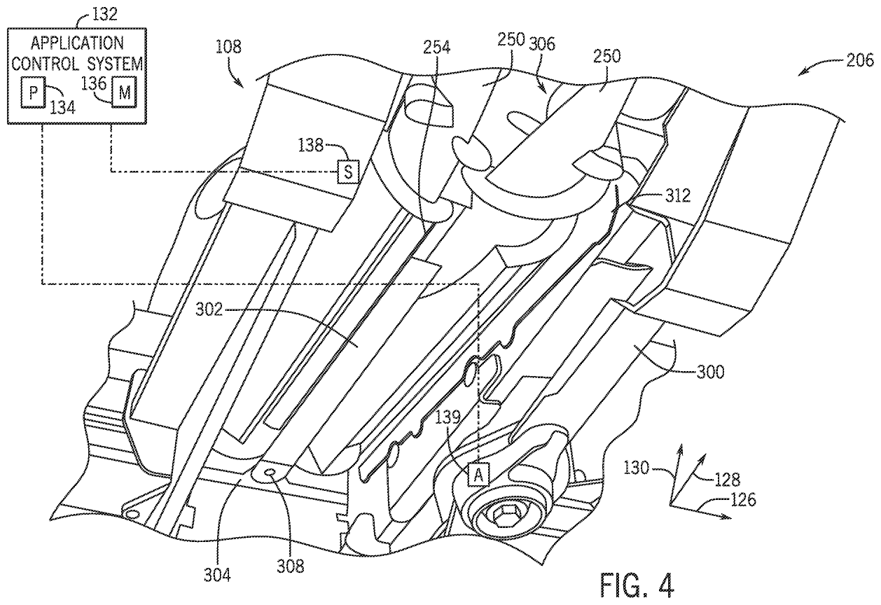

FIG. 4 is a perspective bottom view of a portion of the header 108 of FIGS. 2-3. The header 108 includes a chopper 300 configured to rotate to cut stalks/crop residue that is being directed downwardly by the feed rollers 250. As discussed herein, the feed rollers 250 may direct the crop residue downwardly through the gap 254 for discharge from the header 108. While the feed rollers 250 direct the crop residue through the gap 254, the chopper 300 may to cut the crop residue, thereby reducing a size of the crop residue being discharged from the header 108. In additional or alternative embodiments, the feed rollers 250 may include blades, knives, discs, or a combination thereof, that may cut the crop residue during rotation of the feed rollers 250 to reduce the size of the crop residue (e.g., prior to or without cutting by the chopper).

The fluid applicator 139 may be coupled to the chopper 300 and may apply harvest-aid fluid to the chopper 300 to facilitate harvest operation. For example, the application control system 132 may output a control signal to the fluid applicator 139 to apply fluid to the chopper 300 such that the fluid is transferred from the chopper blade to the crop residue (e.g., in response to receiving sensor data indicative of the incoming crop being above a threshold size). The application control system 132 may also output a control signal to the fluid applicator 139 to control the current application rate of fluid to the chopper. For example, the application control system 132 may determine a different amount of crops to be chopped by the chopper 300 than is currently being chopped and adjust the amount of fluid such that the amount of fluid being applied to the cut crop residue is associated with the amount of crop residue being generated by the agricultural system 100.

The header 108 also includes a counter knife 302 (e.g., a counter blade), which may facilitate operation of the chopper 300 in cutting the crop residue. For example, the counter knife 302 may support the crop residue being moved by the feed rollers 250 and provide resistance to enable the chopper 300 to cut the crop residue more easily. For example, the chopper 300 may cut the crop residue against the counter knife 302 such that each of the chopper 300 and the counter knife 302 imparts a force against the crop residue to cut the crop residue. As such, the counter knife 302 may improve operation of the chopper 300. The counter knife 302 may be coupled to the row unit 206, such as to a support 304, and may extend toward a front end 306 (e.g., an upstream end, a tip) of the header 108, such as generally in the longitudinal axis 128. Thus, a portion of the counter knife 302 may overlap with the chopper 300 during rotation of the chopper 300 to enable the counter knife 302 to contact and support the crop residue being cut by the chopper 300. In some embodiments, the fluid applicator 139 may be disposed along the counter knife 302 and be configured to apply harvest-aid fluid to the cutting edge of the counter knife 302. In certain embodiments, the application control system 132 may apply harvest-aid fluid to the chopper 300 and the counter knife 302 in different amounts. In some embodiments, the fluid applicator 139 may apply the harvest-aid fluid to the leading edge of the counter knife 302 in specified locations along the leading edge based on the amount of crops cut by each portion of the counter knife 302. For example, if the application control system 302 determines that the center of the counter knife 302 is where the majority of crops are cut, the fluid applicator 139 may apply the majority of harvest-aid fluid to the center of the counter knife 302 and a minority of fluid, or no fluid, to the far ends of the counter knife 302.

In some embodiments, the position of the counter knife 302 may be adjustable. For example, the counter knife 302 may be coupled to the support 304 at a pivot 308, and the counter knife 302 may be rotated about the vertical axis 130 at the pivot 308 to adjust a direction of extension of the counter knife 302. Such movement of the counter knife 302 may adjust an overlap between the counter knife 302 and the chopper 300 during rotation of the chopper 300. For example, the counter knife 302 may be moved to adjust a force imparted by the counter knife 302 onto the crop residue, to adjust a location (e.g., along a length of the feed rollers 250) where the counter knife 302 engages the crop residue, or to otherwise adjust how the crop residue is cut via the chopper 300. Movement of the counter knife 302 to increase extension toward the front end 306 (e.g., to extend more in the longitudinal direction 128) may enable the chopper 300 to cut the crop residue more aggressively (e.g., more finely into relatively smaller particles). Movement of the counter knife 302 to reduce extension toward the front end 306 (e.g., to extend more in the lateral direction 126) may reduce cutting aggression by the chopper 300 (e.g., to cut the crop residue more coarsely into relatively larger particles). In alternative embodiments of the agricultural system, the counter knife 302 may have a different configuration (e.g., the counter knife 302 may have a different geometry, such as a triangular shape), the counter knife 302 may be moved in a different manner (e.g., translated toward or away from the front end 306), or the counter knife 302 may be omitted.

The header 108 further includes one more anti-wrap knives 312. The anti-wrap knife/knives 312 may block entanglement of the crop residue around the feed rollers 250. As an example, a respective anti-wrap knife 312 may be positioned laterally adjacent to each feed roller 250. A portion of the crop residue may remain in engagement with one of the feed rollers 250 during rotation of the feed roller 250, such that the crop residue is at least partially wrapped about the feed roller 250, potentially bypassing the chopper 300. However, the anti-wrap knife 312 adjacent to the feed roller 250 may cut the crop residue to block continued movement of the crop residue about the feed roller 250, thereby enabling discharge of the crop residue from the header 108. Rotation of the feed roller 250 may drive the crop residue toward the anti-wrap knife 312, which may cut the crop residue and block the crop residue from further entangling the feed roller 250.

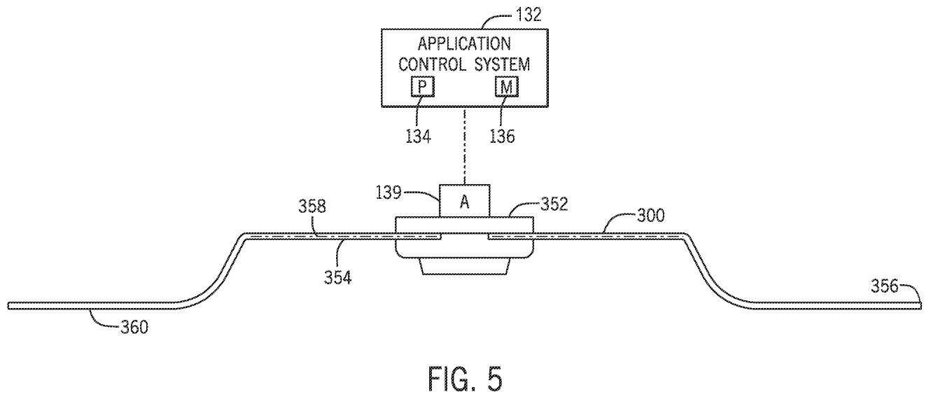

FIG. 5 is a front view of a chopper system 350 that may be employed within the header of FIGS. 2-3. The chopper system 350 includes the chopper 300, the fluid applicator 139, and the application control system 132. As previously mentioned, the fluid applicator 139 may receive instructions from the application control system 132 with regard to applying fluid to the chopper 300. In some embodiments, the fluid applicator 139 may be disposed at the chopper center 352 and apply the fluid directly to the center of the chopper. In some other embodiments, the connection between the application control system 132 and the fluid applicator may be a wired connection. In some other embodiments, the connection between the application control system 132 and the fluid applicator 139 may be a wireless connection. The fluid applicator 139 may include one or more fluid pathways, valves, applicators, actuators, pumps, hydraulic devices, fluid tanks, and the like.

In some embodiments, the fluid applicator 139 may apply the fluid to the chopper center 352 as the chopper 300 is rotating and during harvest operations. In this way, the fluid that is applied near the center of the blade will begin to travel further from the center of the chopper along the chopper blade 354 as centrifugal forces pull the fluid towards a chopper end 356. The chopper end 356 represents the furthest point from the chopper center 352 that rotates and is able to chop crop residue during operation. As the fluid travels along the chopper blades 354, and the chopper blades 354 come into contact with crop residue (e.g., corn stalks) as the chopper 300 rotates, the fluid applied to the chopper 300 is delivered from the chopper 300 to the crop residue as it is chopped. Each corn stalk that is cut receives an amount of fluid to its cut end. In this way, harvest-aid fluid is applied directly to recently cut crop residue. By applying harvest-aid fluid to the crop residue as it is being cut, the agricultural system is not wasting additional harvest-aid fluid that may have otherwise been sprayed into the soil or not applied proportionately to the amount of crop residue generated by the harvester.

The chopper blades 354 may rotate at a great enough speed such that the rotation of the chopper 300 may cause the fluid to run off the sides of the chopper blades 354. Accordingly, in some embodiments, the chopper 300 may include a channel 358 disposed along the chopper blade 354. The channel 358 may enable fluid to travel from the chopper center 352 toward the chopper ends 356 on either end of the chopper 300. The fluid may travel along the channel 358 as the chopper 300 rotates to block the fluid from leaving the chopper blade 354 before reaching the cutting edge 360 of the chopper. To distribute the fluid across the entire chopper 300 and provide enhanced coating of the cutting edge 360, the channels 358 may slow the speed at which fluid reaches the edge of the chopper blade 354. In some embodiments, the channel 358 may be internally disposed within the chopper 300. In some other embodiments, the channel 358 may be an open channel that is partially recessed within the chopper 358 In these embodiments, the channel 358 may include one or more outlets between the channel 358 and the cutting edge 360 of the chopper 300. In this way, the one or more outlets may be positioned at specific locations along the length of the chopper 300 to apply fluid to the cutting edge 360. The outlets may be located at predetermined locations of interest in which more or less fluid is desired. In some embodiments, the outlets may be located directly on the cutting edge 360 of the chopper 300. In this way, the fluid may travel through the channel 358 and be applied directly to the crop residue as the outlets make contact with the crop residue.

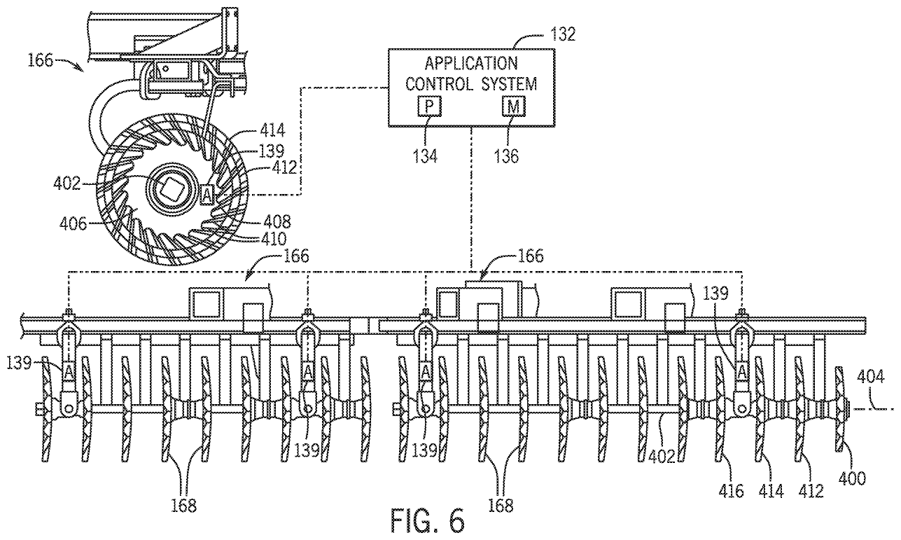

FIG. 6 is a side view and a front view of a row of disc blades 168 that may be employed within the tillage implement of the agricultural system of FIG. 1. A first disc blade 400 is located on the end of the gang 166. The first disc blade 400 is permitted to freely rotate around an axle 402 that is aligned along a rotational axis 404. The first disc blade 400 has a flat center portion 406 and a series of crests and troughs 408, as shown, extending radially inward from the outer periphery of the first disc blade 400. The series of crests and troughs 408 forms multiple flutes 410.

Also connected to the axle 402 are a second disc blade 412, a third disc blade 414, a fourth disc blade 416, and a number of other disc blades 168 which may have similar surface features as the first disc blade 400. As shown in FIG. 4, the disc blades 168 are arranged such that disc blade 168 with the smallest diameter, in this case the first disc blade 400, is positioned on the outermost position in the gang 166 of disc blades 168. The second disc blade 412, which has a larger diameter than the first disc blade 400 is positioned in the second outermost position in the gang 166 of disc blades 168. Continuing inward, the third disc blade 414 and the fourth disc blade 416 are also connected to the axle 402. Both the third disc blade 414 and the fourth disc blade 416 have a greater diameter than the second disc blade 412. In addition, as shown, the third disc blade 414 and the fourth disc blade 416 have similar diameters as do all subsequent disc blades further positioned down the gang 166 of disc blades 168.

Although the gang 166 has three different disc blade diameters in the illustrated embodiment, in other embodiments, the number of disc blades 168 having different diameters may vary. Additionally, in the illustrated embodiment, the disc blade diameters decrease and then remain uniform across the row. However, in other embodiments, other disc blade configurations are possible, and this disclosure is not limited to a particular configuration of disc blades 168.

In certain embodiments, the disc blade diameters and disc blade locations along the axles 404 may be indexed to enhance the performance of the tillage system during operation. Based on the angle at which each of the gangs 166 of disc blades 168 is positioned, the spacing and diameters of the disc blades 168 located within each gang 166 may be particularly selected. The disc blades 168 may be arranged on the gangs 166 such that the disc blades 168 in the rear gangs engage any soil that was not engaged by the disc blades 168 in the front gangs. This configuration may be achieved by offsetting the disc blades 168 in the front gangs relative to the rear gangs by one-half of the blade-to-blade distance.

Although the crests and troughs a-radially extend inward from the outer periphery of the disc blades 168 in the illustrated embodiment, in other embodiments the crests and troughs may extend radially toward the center of the disc blade 168. For example, each of the flutes has a crest and an adjacent trough at the outer periphery, with each crest and adjacent trough extending from the outer periphery in respective adjacent lines. These lines may either be disposed at an acute angle with respect to the radius or be disposed radially.

Moreover, the flutes 410 enable the tillage system to effectively till soil at tilling depths of only 2 inches. The radial nature of the flutes 410 may enable the blades to cover larger swaths of soil than non-fluted concave blades. Additionally, disc blades 168 with a shallow concavity of 1.25 to 1.69 inches may till a wider width of soil than smooth disc blades with the same concavity. Thus, the disc blades 168 may be capable of achieving a sufficiently thorough width of till to depths exceeding the depth of the disc blades' engagement with the soil. In addition, the amount of side pressure that the soil exerts on the disc blades 168 may be reduced, given the disc blades reduced engagement depth with the soil.

The surface of each disc blade 168 can optionally include surface scoring. The scoring may be roughly aligned with the radial or a-radial orientation of the flutes 410 as described above.

Moreover, in the illustrated embodiment, the disc blades 168 are concave. For example, each disc blade may have a shallow concavity between 1.25 and 1.69 inches. These shallow concavities, coupled with the flutes 410, enable the disc blades 168 to operate while substantially reducing or eliminating formation of a subsoil compaction layer.

The fluid applicators 139 may apply a tillage-aid fluid to the disc blades 168 of the tillage implement during operation of the agricultural system. The tillage-aid fluid may be any suitable fluid or substance found within a fluid that aids in the crop development process, such as herbicide, fertilizer, decomposition-aid fluid (e.g., including microbes, materials that promote microbe development), and the like. The application control system 132 may be in communication with one or more fluid applicators 139 disposed along the gang 166 of disc blades 168. The agricultural system may include any suitable number of fluid applicators, and the fluid applicators 139 may be disposed at any suitable position(s) along the gang 166 of disc blades 168. As mentioned previously, the application control system may deliver individual instruction to each fluid applicator 139. In this way, each fluid applicator 139 may receive a different instruction as to the amount of fluid to apply to the respective disc blade 168. For example, the application control system 132 may output a first instruction to a first fluid applicator disposed along a first disc blade with a smaller diameter to apply a smaller amount of fluid to the cutting edge and output a second instruction to a second fluid applicator disposed along a second disc blade with a larger diameter to apply a larger amount of fluid to the cutting edge. In some embodiments, a first fluid applicator may be coupled to one or more disc blades 168. In this way, instructions delivered to the first fluid applicator may include instruction to apply a different amount of fluid to the disc blades. In some embodiments, the fluid applicator 139 may apply the fluid to a center of the disc blade 168 as the disc blade 168 is rotating and during tillage operations. In this way, the fluid that is applied near the center of the blade 168 will begin to travel further from the center of the disc blade 168 as centrifugal forces pull the fluid towards a cutting edge of the disc blade 168

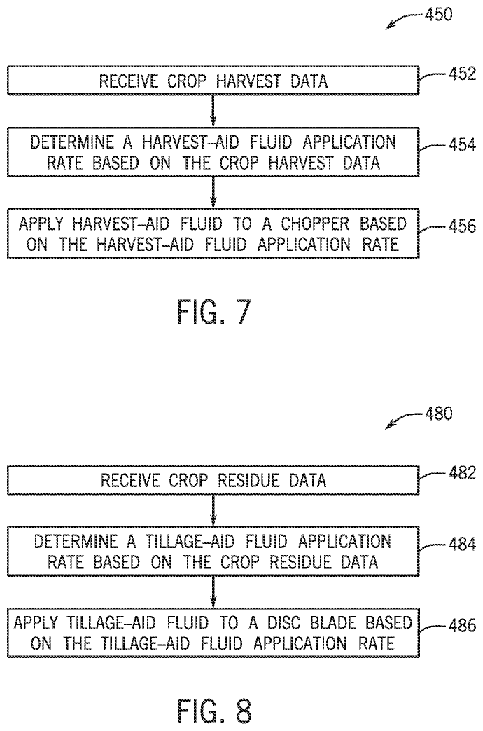

FIG. 7 is a flowchart of an embodiment of a method 450 for operating the agricultural system 100 of FIG. 1 based on crop harvesting data. At block 452, the application control system receives crop harvest data. The crop harvest data may be received from the one or more sensors disposed along the harvester of the agricultural system. The crop harvest data may include data indicative of the harvesting of crops during agricultural operation, such as seed planting data, crop growth data, and the like. The seed planting data may include information as to the geographic location of seeds planted during previous agricultural operations. The geographic location may include a map with areas of high seed planting density differentiated from areas of low seed density. The seed planting data may be received by the application control system from data recorded when the seeds of the current harvest had been planted. For instance, an agricultural device configured to plant seeds (e.g., a corn row planter) may use one or more planting sensors to generate a distribution of seeds across the field. The application control system may receive the distribution of seeds prior to harvesting operation, and the seed planting data may be stored within the memory of the application control system. In some embodiments, the application control system may be communicatively coupled to the planting agricultural device to receive the seed planting data. In some embodiments, the agricultural control system may be independent from the seed planting device, and the application control system may be provided with the seed planting data from an outside source (e.g., a user input, an external database, an external server, a network, and the like).

In some embodiments, the crop harvest data may include crop growth data. Crop growth data may include information indicative of the density of fully grown crops that are ready for harvest. In some embodiments, the crop growth data is obtained by the one or more sensors disposed along the harvester as the harvester is in operation. The application control system may receive the crop growth data in real time or near real time from the sensors. In some embodiments, the crop growth data may be obtained from previous data recordation. For example, an aerial data capturing system may obtain visual data indicative of the amount of crops grown in a given area. In this way, the application control system may receive the crop harvest data from an outside source, similarly to the seed planting data.

In some embodiments, the crop harvest data may include soil and topographic information. The soil and topographic data may be related to a topsoil thickness of the soil in the field, an amount of organic matter within the soil, a level of erosion associated with the soil, a composition of the soil, or any combination thereof. For example, the crop harvest data may include data associated with a percentage of clay in the soil, a percentage of silt in the soil, a percentage of sand in the soil, a percentage of microbial activity in the soil, and the like.

In some embodiments, the crop harvest data may be visually displayed to a user through a user interface located in the cab of the harvester. In this way, the user may be able to adjust the crop harvest data and/or input crop harvest data. For example, a user may provide inputs to account for additional seeds planted in a first location that were planted without data recordation elements present. The user may adjust the crop growth data or input crop growth data via the user interface.

At block 454, the application control system may determine a harvest-aid fluid application rate based on the crop harvest data. As previously described, the application control system is communicatively coupled to the fluid applicator(s) disposed at the chopper(s) within the header of the harvester. The crop harvest data contains information as to the density of crop residue. The application control system may also receive harvest operation data indicative of the harvester speed, harvester direction, chopper speed, chopper angle, and the like. The application control system may determine a rate at which each fluid applicator may apply fluid to the respective chopper to efficiently distribute the harvest-aid fluid to the crop residue generated as a result of the harvest operation. The fluid application rate may be based on the crop harvest data, the harvest operation data, or both. The fluid application rate may be controlled based on the amount of crops the harvester is expected to encounter during operation and the expected/determined path of the harvester. If the application control system receives data indicating that for a first period of time (from the harvest operation data) the harvester is expected to harvest a first amount of crop (from the crop harvest data), the determined fluid application rate may be determined based on the amount of crops expected to be harvested in the timeframe. For example, the application control system may receive crop harvest data indicating that there is a high density of crops during a first 30 seconds of operation, a medium density of crops during a second 30 seconds, and a low density of crops during a third 30 seconds. The determined fluid application rate may include a high rate during the first 30 seconds, a medium rate during the second 30 seconds, and a low rate during the last 30 seconds.

In some embodiments, the fluid application rate may be determined prior to the harvesting operation. In these embodiments, the crop harvest data and the harvest operation data may be received by the application control system prior to the harvesting operation to generate a fluid application rate. For instance, the harvester may operate without the input of a user and determine a fluid application rate, determine a harvest path, and perform harvesting operations with or without user input. The fluid application rate may be a volumetric flow rate of the harvest-aid fluid from the fluid applicator onto the chopper. In some embodiments, the fluid application rate may be directly related to the amount of crops that the application control system determines are to be chopped. For example, the fluid application rate for a 50 meter stretch of field that has 100 corn stalks may be twice as large as that of a 50 meter stretch of field that has 50 corn stalks.

In some embodiments, the application control system may apply a bias to the determined fluid application rate based on a margin of error in the received crop harvest data. For example, the application control system may determine a fluid application rate appropriate for 105 corn stalks in a 1 acre area, when only 100 corn stalks have been indicated based on the crop harvest data. In this way, the determined fluid application rate may be greater than the fluid application rate sufficient for decomposition of the residue within the application area. In some embodiments, the margin of error and/or the bias may be adjusted by a user, a client, a manufacturer, or automatically by the application control system. For example, a user may desire to conserve fluid and set the margin of error/bias to generate a fluid application rate that is lower than the fluid application rate sufficient for decomposition of the residue within the application area.

At block 456, the application control system may apply the harvest-aid fluid to the chopper based on the fluid application rate. The application control system may output instructions to the fluid applicator, in which the instructions include the desired fluid application rate. The instructions may include instructions to adjust one or more pumps, valves, fixtures, mechanical and/or fluid components, or a combination thereof, that are included within the fluid applicator. For example, if the application control system determines that a higher fluid application rate is desired for an upcoming stretch of 50 meters, the application control system may output instructions to the fluid applicator that include opening a valve to cause more fluid to leave the fluid applicator and be applied to the chopper. In some embodiments, the location of fluid application to the chopper may be based on the shape and size of the chopper. As previously mentioned, the fluid applicator may deliver the harvest-aid fluid to the chopper center and enable the centrifugal force of the rotating chopper blades to direct the flow of fluid radially outwardly. In certain embodiments, the chopper may be configured to direct the harvest-aid fluid to the cutting edge of the chopper (e.g., via fluid passage(s), channel(s), etc.). The cutting edge of the chopper may then make contact with the crop residue of harvested crops (e.g., corn stalks) leaving the harvest-aid fluid behind with the crop residue to aid in decomposition.

In some embodiments, one or more fluid applicators may receive different instructions from the application control system to apply a different amount of fluid to different choppers. For example, if the application control system determines through the crop harvest data that the crop density expected to be engaged by the right side of the header is greater than the crop density expected to be engaged by the left side, the fluid applicators on the right side of the header may be instructed to apply more harvest-aid fluid, and the fluid applicators on the left side of the header may be instructed to provide less harvest-aid fluid. For example, if the application control system determines that the right side of the header is expected to receive 100 stalks of corn and the left side of the header is expected to receive 50 stalks of corn, the application control system may output instructions to the fluid applicators disposed at the choppers on the right side to apply more fluid than the fluid applicators disposed at the choppers on the left side. As the chopper comes into contact with stalks of corn, the chopper transfers the fluid currently applied to the chopper to the stalks.

FIG. 8 is a flowchart of an embodiment of a method 480 for operating the agricultural system of FIG. 1 based on crop residue data. At block 482, the application control system receives crop residue data. The crop residue data may be received via the one or more sensors disposed on the tillage system of the agricultural system. The crop residue data may include data indicative of the location and density of crop residue on the field following harvest operations. The density of the crop residue data may be indicative of the amount of detected crop residue in an area of the field. In some embodiments, the application control system may establish a virtual grid across the field and denote each grid element as having a different density of crop residue. The crop residue data received may include the type of crop residue detected (e.g., stems, leaves, stalks, husks, pods). The crop residue data may also include data indicative of soil health, nutrient composition, residue depth within the soil, or a combination thereof. In certain embodiments, the one or more sensors may visually monitor the crop residue. In some embodiments, the application control system may use artificial intelligence (e.g., machine learning) to automatically determine crop residue coverage and/or type based on visual data from the one or more sensors.

In some embodiments, the crop residue data may include a geographic density map of the field (e.g., including areas in which crop residue density is higher and areas in which crop residue density is lower). The crop residue data may be received by the application control system from data recorded when the harvester initially performed harvesting operations that left crop residue on the field (e.g., harvest residue data). For instance, an agricultural device configured to harvest crops (e.g., a harvester) may include one or more sensors, and a controller/control system may use data from the sensors to generate a distribution of crop residue across the field. The application control system may receive the distribution of crop residue prior to tillage operation of the tillage implement, and the crop residue data may be stored within the memory of the application control system. In some embodiments, the crop residue data may be output from the harvester (e.g., a controller of the harvester) of the agricultural system to the application control system. In some embodiments, the agricultural control system may receive the crop residue data from an outside source (e.g., a user input, an external database, an external server, an outside network, a ground-based scout vehicle, an aerial scout vehicle, and the like).

In some embodiments, the crop residue data may include yield map data from the previous harvest. Yield map data may include information indicative of the amount of crops harvested in each location of the field during the previous harvest. In this way, the amount of crop residue may be estimated based on the amount of harvested crops (e.g., more harvested crops corresponds to a higher amount of crop residue left behind).

In some embodiments, the yield map data is obtained from the yield sensor of the harvester. Furthermore, in certain embodiments, the yield map may be determined based on feedback from the one or more sensors disposed along the harvester. For example, as each sensor determines the harvester has harvested a set amount of crop (e.g., a single corn cob), the application control system may record the location of that harvested crop and determine a data set for the yield of the harvest. In some embodiments, the yield map data may be obtained from previous data recordation methods. For example, the application control system may receive the yield map data from an outside source.

In some embodiments, the crop residue data may be visually displayed to a user through a user interface located in the cab of the work vehicle. In this way, the user may be able to adjust the crop residue data and/or input crop residue data. For example, a user may provide inputs to account for undetected variations in the crop residue. The user may adjust the crop residue data or input crop residue data via the user interface.

In certain embodiments, the application control system may receive additional data from the harvester. For example, the additional data may include the soil and topographic information disclosed above, such as data related to a topsoil thickness of the soil in the field, an amount of organic matter within the soil, a level of erosion associated with the soil, a composition of the soil, or any combination thereof. Additionally or alternatively, the additional data may include the amount of harvest-aid fluid applied to the choppers.

At block 484, the application control system may determine a tillage-aid fluid application rate based on the crop residue data. As previously described, the application control system is communicatively coupled to the one or more fluid applicators disposed at the gangs of disc blades on the tillage implement. The application control system may also receive tillage operation data indicative of the tillage speed, tillage direction, disc blade speed, and the like. The application control system may determine a rate at which each fluid applicator may apply fluid to the respective disc blade to efficiently distribute the fluid to the crop residue that remains from previous harvester operations, the soil of the field, or both. The fluid application rate may be based on the crop residue data, the tillage operation data, or both. The fluid application rate may be controlled based on the amount of crop residue the tillage system is expected to encounter during operation and the expected/determined path of the tillage system through the field. For instance, in response to the application control system receiving data indicating that for a first period of time (from the tillage operation data) the tillage system 104 is expected to till a first amount of crop residue and soil (from the crop residue data), the determined fluid application rate may be determined based on the amount of crop residue expected to be encountered in the timeframe. For example, the application control system may receive crop residue data indicating that there is a high density of crop residue during a first 30 seconds of operation, a medium density of crop residue during a second 30 seconds, and a low density of crop residue during a third 30 seconds. The determined fluid application rate may include a high rate during the first 30 seconds, a medium rate during the second 30 seconds, and a low rate during the last 30 seconds.

In some embodiments, the fluid application rate may be determined prior to the tillage operation. In these embodiments, the crop residue data and the tillage operation data may be received by the application control system prior to the tillage operation to generate a fluid application rate plan. For instance, the tillage system may operate automatically without the input of a user and determine a fluid application rate, determine a tillage path, and perform tillage operations with or without user input. The fluid application rate may be a volumetric flow rate of the tillage-aid fluid from the fluid applicator onto the disc blade. In some embodiments, the fluid application rate may be directly related to the amount of crop residue detected on the field. For example, the fluid application rate for a 50 meter stretch of field that has 100 corn stalks worth of residue may be twice as large as that of a 50 meter stretch of field that has 50 corn stalks worth of residue.

In some embodiments, the application control system may apply a bias to the determined fluid application rate based on a margin of error in the received crop residue data. For example, the application control system may determine a fluid application rate appropriate for 105 corn stalks worth of residue in a 1 acre area, when only 100 corn stalks worth of residue have been indicated based on the crop residue data. In this way, the determined fluid application rate may be greater than the fluid application rate sufficient for decomposition of the residue within the application area. In some embodiments, the margin of error and/or the bias may be adjusted by a user, a client, a manufacturer, or automatically by the application control system. For example, a user may desire to conserve fluid to reduce waste and intentionally set the margin of error/bias to generate a fluid application rate that is lower than the fluid application rate sufficient for decomposition of the residue within the application area.

In certain embodiments, the application control system may determine the tillage-aid fluid application rate based on the crop residue data and the additional data received from the harvester. For example, the application control system may determine the tillage-aid fluid application rate based in part on the amount of harvest-aid fluid applied to the choppers. By way of example, a higher tillage-aid application rate may be determined if a lower amount of harvest-aid fluid is applied to the choppers (e.g., no harvest-aid fluid), and a lower tillage-aid application rate may be determined if a higher amount of harvest-aid fluid is applied to the choppers.

At block 486, the application control system may apply the tillage-aid fluid to the one or more disc blades based on the fluid application rate. The application control system may output instructions to the fluid applicator, in which the instructions include the desired fluid application rate. The instructions may include instructions to adjust one or more pumps, valves, fixtures, mechanical and/or fluid components, or a combination thereof, that are included within the fluid applicator. For example, if the application control system determines that a higher fluid application rate is desired for an upcoming stretch of the field, the application control system may output instructions to the fluid applicator that include opening a valve and/or increasing output of a pump to cause more fluid to leave the fluid applicator and be applied to the disc blade.

In some embodiments, the location of fluid application to the disc blade may be based on the shape and size of the disc blade. In some embodiments, the disc blades may be oriented substantially vertically. Accordingly, the fluid applicator may apply tillage-aid fluid directly to the disc blade. In this way, the rotation of the disc blade may enable the cutting edge of the disc blade to be coated as the disc blade cuts the crop residue. The cutting edge of the disc blade may make contact with the crop residue of harvested crops (e.g., corn stalks) leaving the tillage-aid fluid behind with the crop residue to aid in decomposition.

In some embodiments, one or more fluid applicators may receive different instructions from the application control system to apply a different amount of fluid to different disc blades. For example, if the application control system determines from the crop residue data that the crop residue density received by a left gang of disc blades is greater than the crop density received by a right gang of disc blades, the fluid applicators on the right side of the tillage implement may be instructed to apply more tillage-aid fluid, and the fluid applicators on the left side of the tillage implement may be instructed to provide less tillage-aid fluid. For example, if the application control system determines that the right gang of disc blades is expected to cut into 100 corn stalks worth of residue and the left gang of disc blades is expected to cut into 50 corn stalks worth of residue, the application control system may output instructions to the fluid applicators disposed at disc blades on the right gang to apply more fluid than the fluid applicators disposed at disc blades on the left gang. As each disc blade comes into contact with crop residue, the disc blade transfers the fluid currently applied to the disc blade to the residue.

In some embodiments, the method 450 of applying harvest-aid fluid to the choppers and the method 480 of applying tillage-aid fluid to the disc blades may both be executed by the application control system during consecutive agricultural operations. For example, the application control system may determine first fluid application rate(s) for applying harvest-aid fluid to chopper(s) as corn is being harvested, as well as determining second fluid application rate(s) for applying tillage-aid fluid to the disc blade(s) as the soil is being tilled. In this way, the crop residue may receive multiple incorporations of decomposition-aid fluid from both the harvester and the tillage system. By including multiple application passes of the crop residue, decomposition-aid fluid that may have been initially applied and lost over time may be replaced to enhance decomposition and soil health until the next set of seeds is planted.

By incorporating the systems and methods disclosed herein with modern agricultural systems, the application of decomposition-aid fluid to crop residue and field soil may be performed with less wasted decomposition-aid fluid and a more effective incorporation of the fluid within the crop residue. For example, each corn stalk may receive a similar amount of decomposition-aid fluid during harvest operations, and each quantity of residue may receive a similar amount of decomposition-aid fluid during tillage operations. The systems and methods of the present disclosure reduce waste and enhance the efficiency of decomposition-aid fluid application, as compared to spraying decomposition-aid fluid onto the field without regard to residue distribution.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform) ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
a harvester, comprising:
a chopper configured to cut crop residue; and
a fluid applicator configured to apply harvest-aid fluid to the chopper; and
an application control system, comprising a memory and a processor, wherein the application control system is configured to:
receive crop harvest data indicative of a density or an expected density of crops within a field;
determine a harvest-aid fluid application rate based on the crop harvest data; and
control the fluid applicator to apply the harvest-aid fluid to the chopper based on the harvest-aid fluid application rate.

2. The agricultural system of claim 1, comprising:
a tillage system, comprising:
a disc blade configured to till soil and cut the crop residue; and
a second fluid applicator configured to apply tillage-aid fluid to the disc blade;
wherein the application control system is configured to:
receive crop residue data indicative of a location, a density, a species, a size, or a combination thereof, of the crop residue within the field;
determine a tillage-aid fluid application rate based on the crop residue data; and
control the second fluid applicator to apply the tillage-aid fluid to the disc blade based on the tillage-aid fluid application rate.

3. The agricultural system of claim 2, wherein the application control system comprises a plurality of controllers, the fluid applicator of the harvester is communicatively coupled to a first controller of the plurality of controllers, the second fluid applicator of the tillage system is communicatively coupled to a second controller of the plurality of controllers, and the first controller and the second controller operate independently of one another.

4. The agricultural system of claim 1, wherein the crop harvest data comprises crop growth data indicative of the density of the crops within the field.

5. The agricultural system of claim 4, wherein the harvester comprises one or more sensors, the one or more sensors are communicatively coupled to the application control system, the application control system is configured to receive the crop growth data from the one or more sensors during a harvesting operation.

6. The agricultural system of claim 1, wherein the crop harvest data comprises seed planting data indicative of the expected density of the crops within the field.

7. The agricultural system of claim 1, wherein the application control system is configured to receive harvest operation data, the application control system is configured to determine the harvest-aid fluid application rate based on the crop harvest data and the harvest operation data, and the harvest operation data is indicative of a harvester direction, a harvester speed, a chopper speed, a chopper angle, or any combination thereof.

8. The agricultural system of claim 1, wherein the harvest-aid fluid comprises herbicide, fertilizer, decomposition-aid fluid, or any combination thereof.

9. An agricultural system, comprising:
a tillage system, comprising:
a disc blade configured to till soil and cut the crop residue; and
a fluid applicator configured to apply tillage-aid fluid to the disc blade; and
an application control system, comprising a memory and a processor, wherein the application control system is configured to:
receive crop residue data indicative of a location, a density, a species, a size, or any combination thereof, of the crop residue within a field;
determine a tillage-aid fluid application rate based on the crop residue data; and
control the fluid applicator to apply the tillage-aid fluid to the disc blade based on the tillage-aid fluid application rate.

10. The agricultural system of claim 9, wherein the tillage system comprises one or more sensors, the one or more sensors are communicatively coupled to the application control system, the application control system is configured to receive the crop residue data from the one or more sensors during a tillage operation.

11. The agricultural system of claim 9, wherein the application control system is configured to receive tillage operation data, the application control system is configured to determine the tillage-aid fluid application rate based on the tillage operation data and the crop residue data, and the tillage operation data is indicative of a tillage system direction, a tillage system speed, a disc blade speed, a disc blade angle, or any combination thereof.

12. The agricultural system of claim 9, wherein the tillage-aid fluid comprises herbicide, fertilizer, decomposition-aid fluid, or any combination thereof.

13. The agricultural system of claim 9, wherein the crop residue data comprises yield map data indicative of an amount of the crops harvested in each location of the field during a previous harvest operation, harvest residue data indicative of an amount of crop residue generated via a previous harvest operation, or any combination thereof.

14. A fluid application system, comprising:
a cutting blade configured to cut crop vegetation;
an application control system, comprising a processor and a memory, wherein the application control system is configured to:
receive data indicative of the crops within a field; and
determine a fluid application rate based on the received data; and
a fluid applicator configured to apply decomposition-aid fluid to the cutting blade based on the fluid application rate.

15. The fluid application system of claim 14, wherein the cutting blade is oriented horizontally to chop stalks of corn during a harvest operation.

16. The fluid application system of claim 15, wherein the cutting blade is configured to rotate about a rotational axis, and the fluid applicator is configured to apply the decomposition-aid fluid to a center of the cutting blade for distribution along the cutting blade by centrifugal force.

17. The fluid application system of claim 14, wherein the cutting blade is oriented substantially vertically to till soil and incorporate crop residue into the soil.

18. The fluid application system of claim 17, wherein the fluid applicator is configured to apply the decomposition-aid fluid to a cutting edge of the cutting blade as the cutting blade rotates about a rotational axis.

19. The fluid application system of claim 14, wherein the decomposition-aid fluid comprises microbes, materials that promote microbe development, or both.

20. The fluid application system of claim 14, wherein the cutting blade comprises a fluid channel extending from the center of the cutting blade outwardly, wherein the fluid channel is configured to direct fluid from the center of the cutting blade to the cutting edge of the cutting blade as the cutting blade rotates.
